(19) United States
(12) Patent Application Publication
(10) Pub. No.: US 2005/0216857 A1
(43) Pub. Date: Sep. 29, 2005

(54) Information processing technique to support browsing

(75) Inventor: Yoshikatsu Harako, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/899,002

(22) Filed: Jul. 27, 2004

(30) Foreign Application Priority Data
Mar. 24, 2004 (JP) 2004-087027

(51) Int. Cl. G06F 3/00; G06F 17/21

(52) U.S. Cl. 715/781; 715/792; 715/804; 715/501.1; 715/513; 715/782

(57) ABSTRACT

This invention is to support browsing by users. A method of the invention includes extracting a display item which is not displayed in a main window and has a predetermined attribute, and storing data concerning the extracted display item into an auxiliary window data storage; and displaying an auxiliary window, which displays a display item corresponding to the extracted display item, at a specific position on a display screen by using the data concerning the extracted display item, which is stored in the auxiliary window data storage. Thus, by looking at the auxiliary window, the user can grasp the display item of a page portion, which is not originally displayed unless a scroll operation is performed.

### TECHNICAL FIELD OF THE INVENTION

The present invention relates to an information processing technique to support browsing.

### BACKGROUND OF THE INVENTION

In recent years, various Web systems are built because of the development of Internet techniques. As long as a browser function is provided in a terminal operated by a user, the user can use various services without introducing dedicated client programs corresponding to respective server programs. However, Web pages constituting a Web site respectively have various layouts, and there is also a page, which is hard for the user to browse and/or to manipulate.

As one of methods of solving such a problem, for example, JP-A-2003-281093 discloses a technique of displaying the contents of a linked page without screen transition. That is, the user gives an instruction to information linked by hyperlink to other HTML (Hyper Text Markup Language) documents in information existing in a window opened in a browser window, so that the linked information is displayed in the currently opened window with the same look as that obtained by rendering the linked information with the browser.

In addition, there is also a case where it is troublesome to compare display contents at both ends of a page. For example, in the case where the size of one page is large, the user performs a scroll operation to see the whole page. When the scroll is performed, the display contents are also changed. Therefore, for example, in the case of the vertical scroll, the user cannot see a display item at the uppermost part of the page and a display item at the lowermost part of the page at the same time. For example, in the case where an input field exists at the upper part of the page, and a “register” button exists at the lower part of the page, when the input field and the “register” button are not displayed at the same time, the user cannot click the “register” button while confirming that a correct input is made, which is inconvenient. However, the aforementioned related art cannot solve the problem as stated above.

### SUMMARY OF THE INVENTION

An object of the invention is therefore to provide a novel technique to support browsing by users.

An information processing method of the invention includes extracting a display item which is not displayed (i.e. in a non-display state) in a main window and has a predetermined attribute, and storing data concerning the extracted display item into an auxiliary window data storage; and displaying an auxiliary window, which displays a display item corresponding to the extracted display item, at a specific position on a display screen by using the data concerning the extracted display item, which is stored in the auxiliary window data storage.

Thus, by looking at the auxiliary window, the user can grasp the display item of a page portion, which is not originally displayed unless a scroll operation is performed.

In addition, the aforementioned extracting and storing and the aforementioned displaying may be carried out in a case where it is detected that the contents of the main window are changed. For example, there is a case where a scroll is performed so that a button, which was displayed in the main window until now, disappears from the main window. In such a case, by carrying out the aforementioned processing, a display item corresponding to the button, which disappears from the main window, is displayed in the auxiliary window, and the user can continue recognizing the existence of the button, easily. Besides, as factors in changing the contents of the main window, it is possible to enumerate a change of a display page (for example, a change of URL (Uniform Resource Locator)), a change of a display size of the main window, page refreshment of the main window and the like.

The aforementioned displaying may include: searching for a position where the auxiliary window can be displayed without completely covering any display items displayed in the main window; and determining a display position of the auxiliary window on the basis of a result of the searching. By this configuration, the auxiliary window can be displayed at the suitable position. That is, the auxiliary window is displayed at the position where it does not cover any display items displayed in the main window, or even if overlap occurs, it covers only a part of the display item.

Incidentally, a program causing a computer to carry out the aforementioned method is stored in a storage medium or a storage device, for example, a flexible disk, a CD-ROM, a magneto-optical disk, a semiconductor memory, or a hard disk. Besides, there is also a case where the program is distributed as digital signals through a network. Incidentally, intermediate processing data are temporarily stored in a storage device of the computer, such as a main memory.

### BRIEF DESCRIPTION OF THE DRAWINGS

FIG. 1 is a functional block diagram of a user terminal in an embodiment of the invention;

FIG. 2 is a diagram showing an outline of a functional block of a computer in the embodiment of the invention;

FIG. 3 is a diagram showing an example of a table structure of a tag information table and data stored;

FIG. 4 is a diagram showing a processing flow of the embodiment of the invention;

FIG. 5 is a conceptual diagram of a screen area and coordinates;

FIG. 6 is a diagram showing a processing flow of a tag identification information acquisition processing;

FIG. 7 is a diagram showing a processing flow of an auxiliary window display processing;

FIG. 8 is a diagram showing a processing flow of a vertical position determination processing;

FIG. 9 is a diagram showing a processing flow of a horizontal position determination processing;

FIG. 10 is a diagram showing a processing flow of a secondary position determining processing;

FIG. 11A is a diagram showing a first screen example;

FIG. 11B is a diagram showing a second screen example;

FIG. 11C is a diagram showing a third screen example; and

FIG. 12 is a diagram showing a processing flow of an event execution processing.

### DETAILED DESCRIPTION OF THE PREFERRED EMBODIMENTS

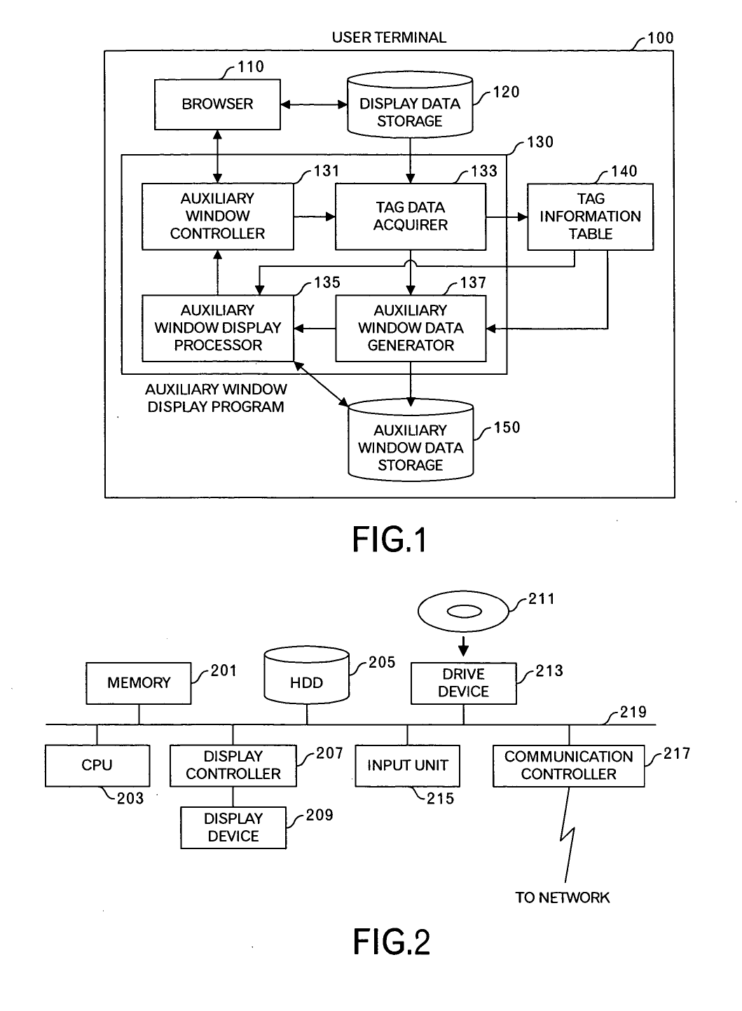

FIG. 1 is a functional block diagram of a user terminal in an embodiment of the invention. A user terminal 100 as, for example, a personal computer includes a browser 110, a display data storage 120, auxiliary window display program 130, tag information table 140, and auxiliary window data storage 150. The auxiliary display program 130 includes an auxiliary window controller 131, tag data acquirer 133, auxiliary window display processor 135, and auxiliary window data generator 137. The browser 110 has a general Web browser function, and operates with the auxiliary window controller 131 together to perform a processing. The browser 110 stores HTML files acquired from a server and data concerning screen layouts including coordinates of display items into the display data storage 120, and refers to them as the need arises. Here, the coordinate is a value indicating a position in a screen display area as, for example, an XY plane. In this embodiment, it is assumed that the coordinate at the upper left corner of the screen display area is (0, 0), and the value becomes large toward the right direction and the lower direction. Incidentally, the display data storage 120 may be included in the browser 110. That is, the auxiliary window controller 131 may directly receive the data concerning the screen layout from the browser 110.

The auxiliary window controller 131 of the auxiliary window display program 130 operates together with the browser 110, and when detecting that the display contents of the main window are changed, the auxiliary window controller 131 notifies the tag data acquirer 133 to that effect. Besides, when detecting that an instruction operation is performed from the user to the auxiliary window, the auxiliary window controller 131 outputs data corresponding to the instruction operation to the browser 110.

The tag data acquirer 133 refers to the display data storage 120 to perform a processing, and stores data concerning a tag corresponding to a display item into the tag information table 140. When the processing is ended, it notifies the auxiliary window data generator 137 to that effect. The auxiliary window data generator 137 refers to the tag information table 140 to perform a processing, and stores data concerning a display item to be displayed in the auxiliary window into the auxiliary window data storage 150. When the processing is ended, it notifies the auxiliary window display processor 135 to that effect. The auxiliary window display processor 135 refers to the tag information table 140 and auxiliary window data storage 150 to perform a processing, and stores data concerning a display position of the auxiliary window into the auxiliary window data storage 150. When the processing is ended, it notifies the auxiliary window controller 131 to that effect.

Incidentally, the user terminal 100 is a computer as shown in FIG. 2. A memory 201, CPU 203, hard disk drive (HDD) 205, display controller 207 connected to a display device 209, drive device 213 for a removable disk 211, input device 215, and communication controller 217 for connection with a network are connected through a bus 219. An operating system (OS: Operating System) and application programs including a program for realizing the processing of this embodiment are stored in the HDD 205, and are read out from the HDD 205 to the memory 201 when executed by the CPU 203. As the need arises, the CPU 203 controls the display controller 207, communication controller 217, and drive device 213, and causes them to carry out necessary operations. Data under processing is stored in the memory 201, and if necessary, is stored in the HDD 205. The program for realizing the processing of this embodiment of the invention is stored in, for example, the removable disk 211, is distributed and is installed into the HDD 205 from the drive device 213, or is received through the network and communication controller 217 and is installed into the HDD 205. The computer as stated above realizes various functions as described below by systematic cooperation of the hardware such as the CPU 203 and memory 201 and the OS and necessary application programs.

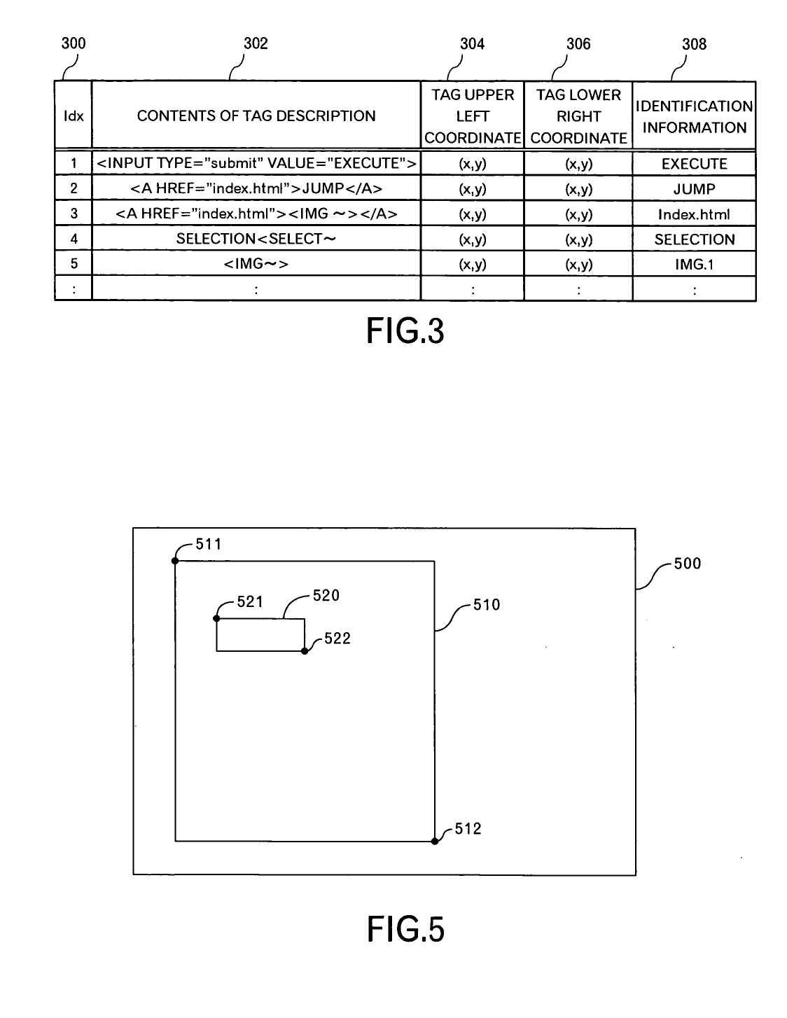

FIG. 3 shows an example of a table structure of the tag information table 140 and data stored. The example of FIG. 3 includes a column 300 of number (Idx), column 302 of contents of tag description, column 304 of tag upper left coordinate, column 306 of tag lower right coordinate, and column 308 of identification information. In this table, data concerning tags corresponding to display items, among tags included in an HTML file, are registered. The coordinate of the upper left corner of the display item corresponding to the tag on the screen is stored in the column 304 of tag upper left coordinate. Similarly, the coordinate of the lower right corner of the display item corresponding to the tag on the screen is stored in the column 306 of tag lower right coordinate. The coordinate data is registered on the basis of the data concerning the screen layout, which is stored in the display data storage 120. A coordinate of a display item not displayed in the main window is also calculated based on, for example, the coordinate of the upper left corner of the main window, and is registered in the display data storage 120. The display contents in a case where the display item corresponding to the tag is displayed in the auxiliary window is registered as identification information of the tag into the column 308 of identification information.

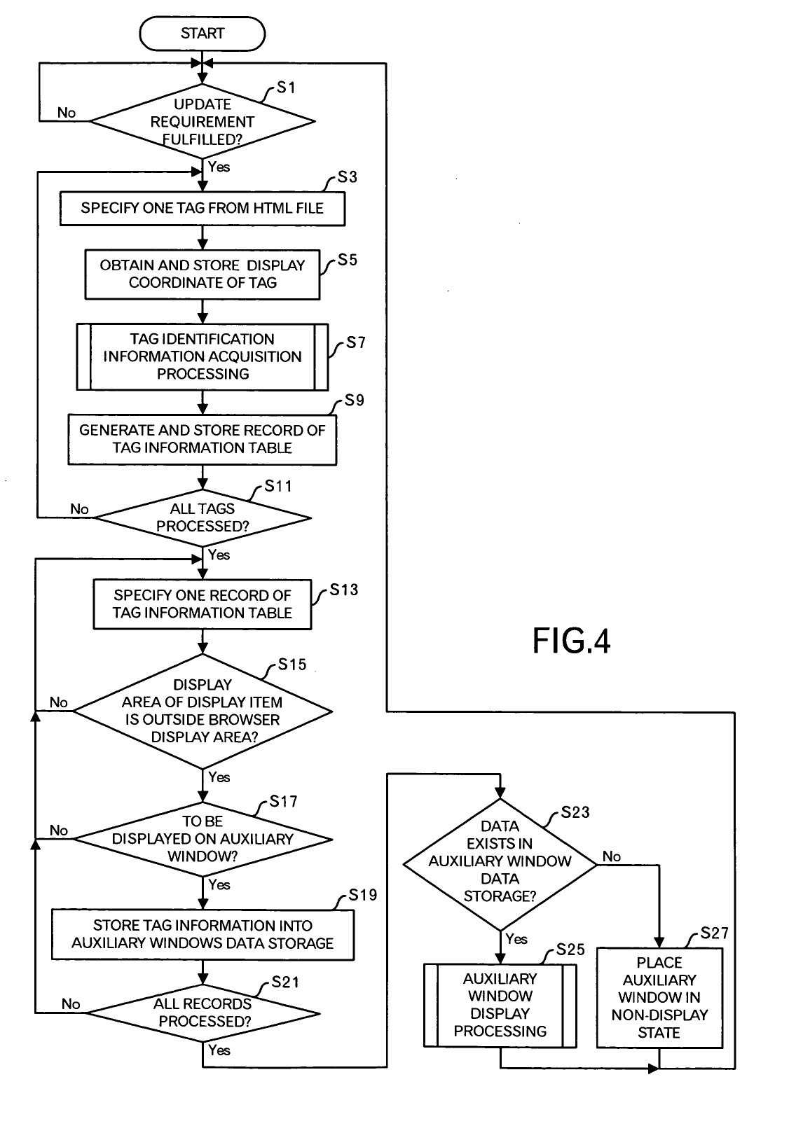

The processing of the auxiliary window display program 130 shown in FIG. 1 will be described with reference to FIGS. 4 to 12. First, the auxiliary window controller 131 of the auxiliary window display program 130 operates together with the browser 110 and judges whether an update requirement of the auxiliary window is fulfilled (FIG. 4: step S1). In a case where it is detected that an instruction to change a page displayed in the main window, to change a display size of the main window, to refresh a page, or to change a display position of the main window is issued by a user or is automatically issued, it judges that the update requirement is fulfilled.

In the case where it is judged that the update requirement of the auxiliary window is not fulfilled (step S1: No route), monitoring of the update requirement is continuously performed. On the other hand, in the case where it is judged that the update requirement of the auxiliary window is fulfilled (step S1: Yes route), the tag data acquirer 133 specifies one tag corresponding to a display item from the HTML file stored in the display data storage 120 (step S3). However, an HTML tag and BR tag are not specified, for example. It is assumed that before the first processing of the step S3 is performed, data of the tag information table 140 and auxiliary window data storage 150 are cleared.

Incidentally, at the step S1, in a case where the update requirement of the auxiliary window is the change of the display position of the main window, a processing may shift to step S25 described later. This is because the contents displayed in the main window and auxiliary window is not changed.

Next, the tag data acquirer 133 acquires the coordinate corresponding to the specified tag from the display data storage 120, and temporarily stores it into a storage device such as a work memory area (step S5). The tag data acquirer 133 performs a tag identification information acquisition processing (step S7). Although the details of the tag identification information acquisition processing will be described later, as a result of the processing, the identification information corresponding to the tag is determined.

The tag data acquirer 133 uses the processing result of the steps S3 to S7 to generate record data of the tag information table 140, and stores it into the tag information table 140 (step S9). The tag data acquirer 133 judges whether the processing is performed with respect to all tags included in the HTML file (step S11). In a case where it is judged that the processing is not performed with respect to all the tags (step S11: No route), the processing returns the step S3, and a next tag is specified.

On the other hand, in a case where it is judged that the processing is performed with respect to all the tags (step S11: Yes route), the auxiliary window data generator 137 specifies one record in the tag information table 140 (step S13). The auxiliary window data generator 137 judges whether the display area of the display item corresponding to the specified record is outside the display area of the main window (i.e. browser display screen) (step S15). In this judgment, the coordinates corresponding to the tag and the coordinates of the display area of the main window are used. The coordinates of the display area of the main window may be acquired from the browser 110, or data stored in the display data storage 120 may be used.

For example, in a case where the upper left coordinate corresponding to the tag is (X1, Y1), the lower right coordinate is (X2, Y2), the upper left coordinate of the display area of the main window is (X3, Y3), and the lower right coordinate is (X4, Y4), when a following expression (1) is established, it judges that the display area of the display item corresponding to the tag is outside the display area of the main window.
X1>X4 or Y1>Y4 or X2<X3 or Y2<Y3 (1)

FIG. 5 shows a conceptual diagram of a screen area and coordinates. In the example of FIG. 5, a display area 510 of the main window is displayed inside a screen display area 500. Moreover, a display area 520 of a display item is displayed inside the display area 510 of the main window. Here, for example, when the value of the X coordinate of a point 521, which is the upper left corner of the display area 520 of the display item, is larger than the value of the X coordinate of a point 512, which is the lower right corner of the display area 510 of the main window, the display area 520 of the display item is positioned on the right of the display area 510 of the main window. That is, the display item is not displayed in the main window. Similarly, for example, when the value of the Y coordinate of a point 522, which is the lower right corner of the display area 520 of the display item, is smaller than the value of the Y coordinate, which is a point 511 of the upper left corner of the display area 510 of the main window, the display area 520 of the display item is positioned above the display area 510 of the main window. That is, the display item is not displayed in the main window. At the step S15 (FIG. 4), the judgment as stated above is performed.

Returning to the description of FIG. 4, in a case where it is judged at the judgment processing of the step S15 that the display area of the display item is not outside the display area of the main window (No route), the processing returns to the step S13, and a next record is specified. On the other hand, in the case where it is judged that the display area of the display item is outside the display area of the main window (step S15: Yes route), the auxiliary window data generator 137 judges whether the display item corresponding to the record specified at the step S13 is to be displayed on the auxiliary window (step S17). In this embodiment, a judgment is made on the basis of a value in the column 302 of contents of tag description (shown in FIG. 3) for the record, and it judges that in a case where an event handler is contained, in a case where a link is embedded, or in a case of an INPUT tag, the display item corresponding to the record is to be displayed on the auxiliary window.

In the case where the display item is judged not to be displayed (step S17: No route), the processing returns to the step S13, and a next record is specified. On the other hand, in the case where the display item is judged to be displayed (step S17, Yes route), the auxiliary window data generator 137 stores the value in the column 308 (shown in FIG. 3) of identification information for the record into the auxiliary window data storage 150 (step S19).

The auxiliary window data generator 137 judges whether the processing for all the records in the tag information table 140 is ended (step S21). In the case where it is judged that the processing for all the records is not ended (step S21: No route), the processing returns to the step S13, and a next record is specified. On the other hand, in the case where it is judged that the processing for all the records is ended (step S21: Yes route), the auxiliary window display processor 135 refers to the auxiliary window data storage 150 and judges whether data exists in the auxiliary window data storage (step S23). In the case where it is judged that the data exists in the auxiliary window data storage 150 (step S23: Yes route) the auxiliary window display processor 135 performs an auxiliary window display processing (step S25). Although the details of the auxiliary window display processing will be described later, as a result of the processing, the auxiliary window is displayed at a suitable position on the screen area. Then, the processing returns to the step S1.

On the other hand, in the case where it is judged that the data does not exist in the auxiliary window data storage 150 (step S23: No route), the auxiliary window display processor 135 causes the auxiliary window not to be displayed (step S27). When the auxiliary window is displayed, it is closed, and when not displayed, nothing is performed. Then, the processing returns to the step S1.

In this way, with respect to the display item not displayed in the main window, the presentation by the auxiliary window is performed. Thus, the user can grasp the outline of the entire page without performing the scroll operation.

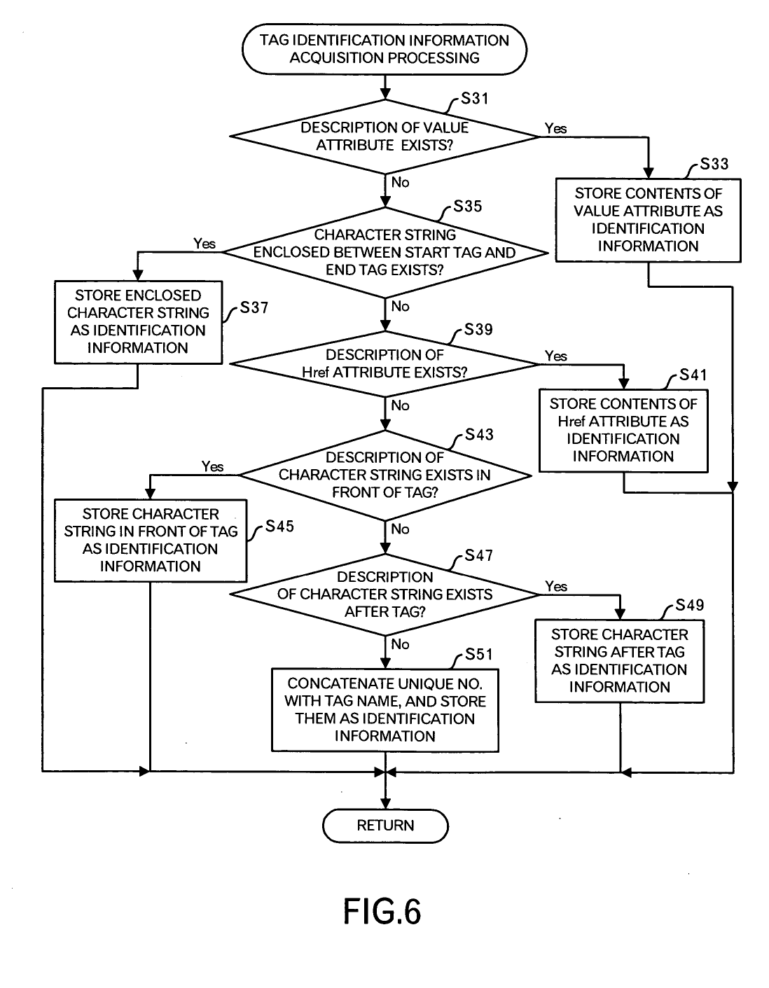

The details of the tag identification information acquisition processing (FIG. 4: step S7) are described with reference to FIG. 6. First, the tag data acquirer 133 judges whether a description of a value attribute exists in the tag specified at the step S3 (FIG. 4) (FIG. 6: step S31). In the case where it is judged that the description of the value attribute exists (step S31: Yes route), it stores the contents of the value attribute as the identification information into the storage device such as the work memory area (step S33). For example, in the case where the description of the HTML is “<INPUT TYPE=“submit” VALUE=“execute”>”, “execute” as the contents of the value attribute is specified as the identification information. Then, the tag identification information acquisition processing is ended, and the processing is returned to the original processing.

On the other hand, in the case where it is judged that the description of the value attribute does not exist (step S31: No route), the tag data acquirer 133 judges whether a character string enclosed between a start tag and an end tag exists (step S35). In the case where it is judged that the character string enclosed between the start tag and the end tag exists (step S35: Yes route), it stores the character string enclosed between the start tag and the end tag as the identification information into the storage device such as the work memory area (step S37). For example, in the case where the description of the HTML is “<A HREF=“index.html”>jump</A>”, “jump” as the character string enclosed between the start tag and the end tag is specified as the identification information. Then, the tag identification information acquisition processing is ended, and the processing is returned to the original processing.

On the other hand, in the case where it is judged that the character string enclosed between the start tag and the end tag does not exist (step S35; No route), the tag data acquirer 133 judges whether a description of an Href attribute exists (step S39). In the case where the description of the Href attribute exists (step S39: Yes route), it stores the contents of the Href attribute as the identification information into the storage device such as the work memory area (step S41). For example, in the case where the description of the HTML is “<A HREF=“index.html”><IMG˜></A>”, “index.html” as the contents of the Href attribute is specified as the identification information. Then, the tag identification information acquisition processing is ended, and the processing is returned to the original processing.

On the other hand, in the case where it is judged that the description of the Href attribute does not exist (step S39: No route) the tag data acquirer 133 judges whether a description of a character string exists in front of a tag (step S43). In the case where it is judged that the description of the character string exists in front of the tag (step S39: Yes route), it stores the character string in front of the tag as the identification information into the storage device such as the work memory area (step S45). For example, in the case where the description of the HTML is “selection <SELECT˜”, it specifies “selection” as the character string in front of the tag as the identification information. Then, the tag identification information acquisition processing is ended, and the processing returns to the original processing.

On the other hand, in the case where it is judged that the character string does not exist in front of the tag (step S43: No route), the tag data acquirer 133 judges whether a description of a character string exists after a tag (step S47). In the case where the description of the character string exists after the tag (step S47: Yes route), it stores the character string after the tag as the identification information into the storage device such as the work memory area (step S49). For example, in the case where the description of the HTML is “<IMG˜>image”, it specifies “image” as the character string after the tag as the identification information. Then, the tag identification information acquisition processing is ended, and the processing returns to the original processing.

On the other hand, in the case where it is judged that the character string does not exist after the tag (step S47: No route), the tag data acquirer 133 concatenates a unique number with a tag name, and stores them as the identification information into the storage device such as the work memory area (step S51). For example, in the case where the description of the HTML is “<IMG˜>”, for example, “IMG.1” in which the number “1” is concatenated to “IMG” is specified as the identification information. Then, the tag identification information acquisition processing is ended, and the processing returns to the original processing.

In this way, the tag identification information acquisition processing is performed. Since the identification information is stored in, for example, the work memory area, the record of the tag information table 140 is generated using this identification information after this processing is completed.

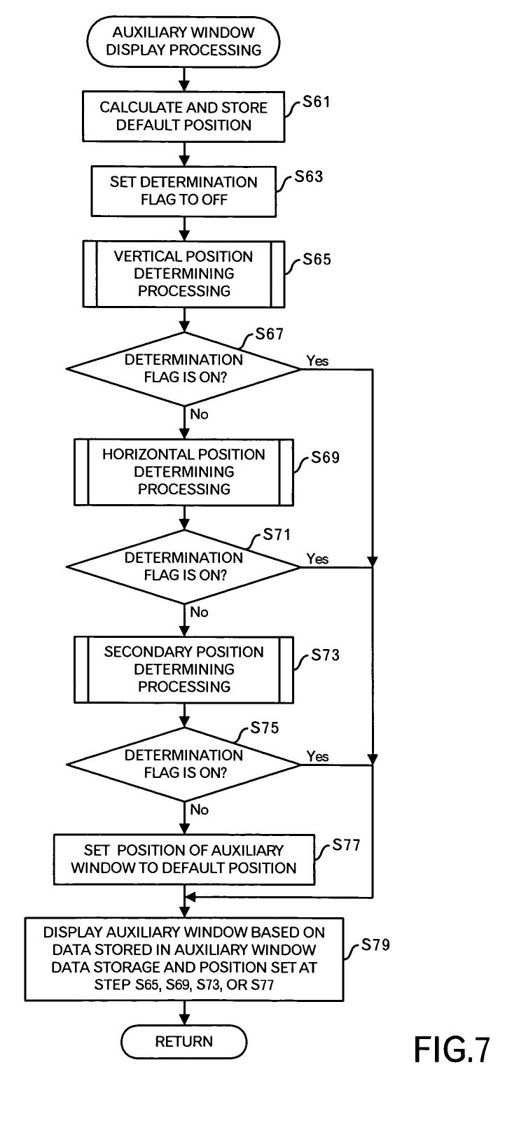

The details of the auxiliary window display processing (FIG. 4: step S25) are described with reference to FIG. 7. First, the auxiliary window display processor 135 calculates a default position of the auxiliary window, and stores position (coordinate) data into the storage device such as the work memory area (FIG. 7: step S61). In this embodiment, the default position of the auxiliary window is a position that is inscribed to the lower right of the main window.

For example, in the case where the lower right coordinate of the display area of the main window is (X4, Y4), the upper left coordinate (X1, Y1) and lower right coordinate (X2, Y2) of the auxiliary window are calculated using a following expression (2). Incidentally, the width and height of the auxiliary window may be determined in advance or may be set in accordance with the number and size of display items stored in the auxiliary window data storage 150.
X2=X4
Y2=Y4
X1=X2−width of auxiliary window
Y1=Y2−height of auxiliary window (2)

The auxiliary window display processor 135 sets a determination flag, which is used to judge whether the position of the auxiliary window is determined, to “OFF”, and stores it into the storage device such as the work memory area (step S63). Next, the auxiliary window display processor 135 performs a vertical position determining processing (step S65). The details of the vertical position determining processing will be described later. The auxiliary window display processor 135 judges whether as a result of the vertical position determining processing, the determination flag is set to “ON” (step S67). In the case where the flag is judged to be set to “ON” (step S67; Yes route), the processing shifts to step S79 described later.

On the other hand, in the case where the flag is judged not to be set to “ON” (step S67: No route), the auxiliary window display processor 135 performs a horizontal position determining processing (step S69). The details of the horizontal position determining processing will be described later. The auxiliary window display processor 135 judges whether as a result of the horizontal position determining processing, the determination flag is set to “ON” (step S71). In the case where the flag is judged to be set to “ON” (step S71: Yes route), the processing shifts to the step S79 described later.

On the other hand, in the case where the flag is judged not to be set to “ON” (step S71: No route), the auxiliary window display processor 135 performs a secondary position determining processing (step S73). The details of the secondary position determining processing will be described later. The auxiliary window display processor 135 judges whether as a result of the secondary position determining processing, the determination flag is set to “ON” (step S75). In the case where the flag is judged to be set to “ON” (step S75: Yes route), the processing shifts to the step S79 described later.

On the other hand, in the case where the flag is judged not to be set to “ON” (step S75: No route), the auxiliary window display processor 135 sets the position of the auxiliary window to the default (step S77). That is, it determines the upper left coordinate and lower right coordinate of the auxiliary window to the coordinates obtained at the step S61.

The auxiliary window display processor 135 uses the data stored in the auxiliary window data storage 150 and the above set position data of the auxiliary window to display the auxiliary window on the screen (step S79). Then, the processing returns to the original processing.

The auxiliary window display processing is performed in this way, and the auxiliary window is displayed at the position determined by the vertical position determining processing, horizontal position determining processing or the secondary position determining processing, or the default position.

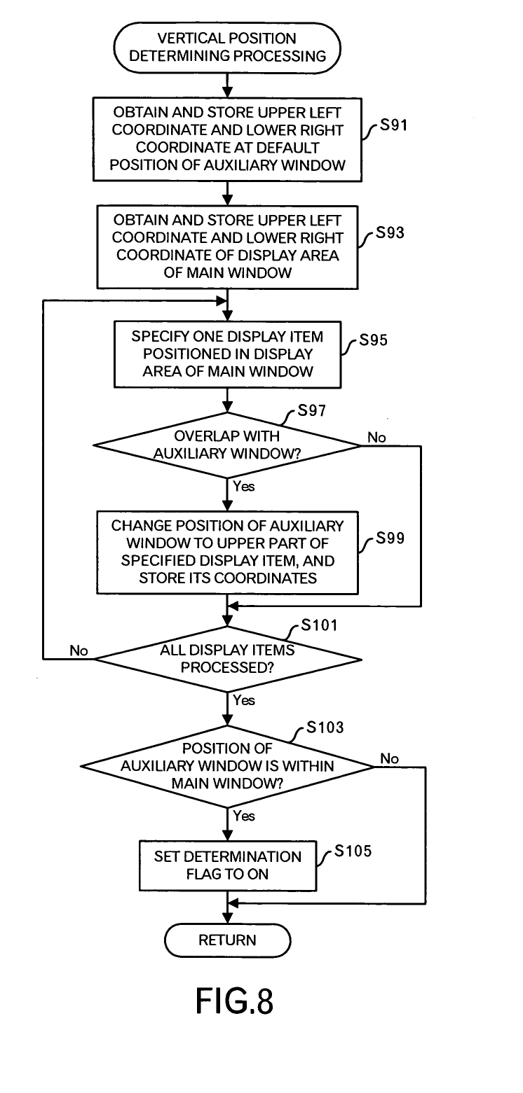

The details of the vertical position determining processing (FIG. 7: step S65) are described with reference to FIG. 8. First, the auxiliary window display processor 135 acquires the upper left coordinate and lower right coordinate at the default position of the auxiliary window, and stores them as a temporal auxiliary window display position into the storage device such as the work memory area (FIG. 8: step S91). Incidentally, these coordinates are calculated at step S61 (FIG. 7). Next, the auxiliary window display processor 135 acquires the upper left coordinate and lower right coordinate of the display area of the main window, and stores them into the storage device such as the work memory area (step S93). The coordinates of the display area of the main window may be acquired from the browser 110, or data stored in the display data storage 120 may be used.

The auxiliary window display processor 135 refers to the tag information table 140, and specifies one display item positioned in the display area of the main window (step S95). For example, in a case where the upper left coordinate of the display item is (X5, Y5), the lower right coordinate thereof is (X6, Y6), the upper left coordinate of the display area of the main window is (X3, Y3), and the lower right coordinate thereof is (X4, Y4), it specifies one display item in which a following expression (3) is established.
X5>X3 and Y5>Y3 and X6<X4 and Y6<Y4 (3)

The auxiliary window display processor 135 judges whether the specified display item overlaps with the auxiliary window (step S97) For example, in the case where the upper left coordinate of the display item is (X5, Y5), the lower right coordinate thereof is (X6, Y6), the upper left coordinate of the display area of the auxiliary window is (X1, Y1), and the lower right coordinate thereof is (X2, Y2), when a following expression (4) is established, it judges that the display item is covered by the auxiliary window.
X5>X1 and Y5>Y1 and X6<X2 and Y6<Y2 (4)

In the case where it is judged that the display item is not covered by the auxiliary window (step S97: No route), the processing shifts to step S101 described later. On the other hand, in the case where it is judged that the display item is covered by the auxiliary window (step S97: Yes route), the auxiliary window display processor 135 changes the temporal auxiliary window display position to a position that is circumscribed to the upper part of the display area of the specified display item, and stores changed coordinates into the storage device such as the work memory area (step S99). For example, in the case where the upper left coordinate of the display item is (X5, Y5), it updates the upper left coordinate (X1, Y1) and lower right coordinate (X2, Y2) of the auxiliary window using a following expression (5). Incidentally, values of the X coordinates are not changed.
Y2=Y5
Y1=Y2−height of auxiliary window (5)

The auxiliary window display processor 135 judges whether the processing for all display items is completed (step S101). In the case where it is judged that the processing for all the display items is not completed (step S101: No route), the processing returns to the step S95, and a next display item is specified. On the other hand, in the case where it is judged that the processing for all the display items is completed (step S101: Yes route), the auxiliary window display processor 135 judges whether the position of the auxiliary window temporarily set at the present stage is in the display area of the main window (step S103). For example, in the case where the upper left coordinate of the display area of the auxiliary window is (X1, Y1), the lower right coordinate thereof is (X2, Y2), the upper left coordinate of the display area of the main window is (X3, Y3), and the lower right coordinate thereof is (X4, Y4), when a following expression (6) is established, it judges that the position of the auxiliary window is in the display area of the main window.
X1>X3 and Y1>Y3 and X2<X4 and Y2<Y4 (6)

In the case where it is judged that the position of the auxiliary window is not in the display area of the window (step S103: No route), the vertical position determining processing is ended, and the processing returns to the original processing. On the other hand, in the case where it is judged that the position of the auxiliary window is in the display area of the main window (step S103: Yes route), the auxiliary window display processor 135 sets the determination flag stored in the work memory area to “ON” (step S105). Then, the vertical position determining processing is ended, and the processing returns to the original processing.

In this way, the vertical position determining processing is performed. By this processing, in the case where the display item in the main window is covered by the auxiliary window, such setting as to shift the position of the auxiliary window upward is performed. In this embodiment, in the case where the display item is completely concealed by the auxiliary window, the position of the auxiliary window is changed. However, in the case where a part of the display item is concealed by the auxiliary window, the position of the auxiliary window may be changed. In that case, instead of the above expression (4), a following expression (7) is applied, and in a case where the expression (7) is established at the step S97, it judges that the display item overlaps with the auxiliary window.
(X1<X5<X2 and Y1<Y5<Y2) or
(X1<X6<X2 and Y1<Y6<Y2) or
(X1<X5<X2 and Y1<Y6<Y2) or
(X1<X6<X2 and Y1<Y5<Y2) (7)

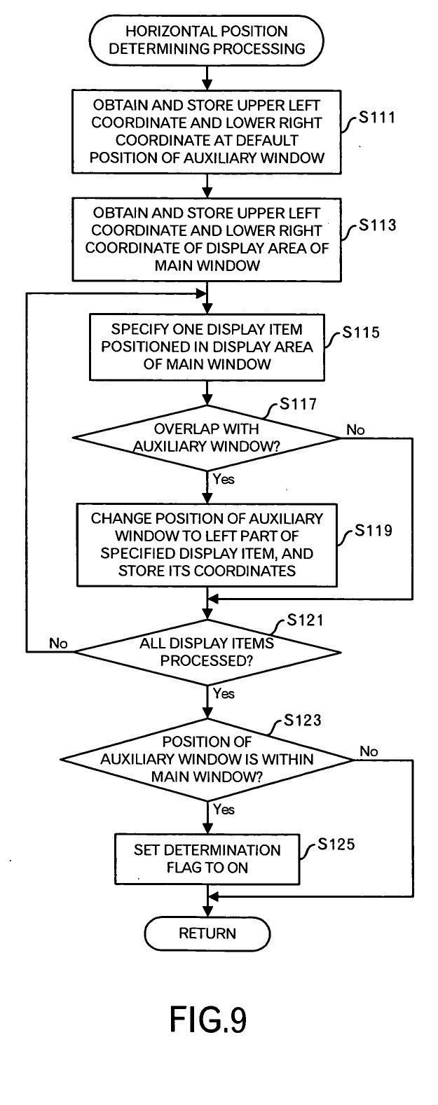

FIG. 9 shows a detailed processing flow of the horizontal position determining processing (FIG. 7: step S69). In the horizontal position determining processing, the processing at the step S99 (FIG. 8) in the vertical position determining processing described above is changed to processing at step S119, and because other steps are the same, their description will be omitted. In the horizontal position determining processing, the auxiliary window display processor 135 changes the temporal auxiliary window display position to a position that is circumscribed to the left of the display area of the specified display item, and stores changed coordinates into the storage device such as the work memory area (FIG. 9: step S119). For example, in the case where the upper left coordinate of the display item is (X5, Y5), the upper left coordinate (X1, Y1) and lower right coordinate (X2, Y2) of the auxiliary window are updated by using a following expression (8). Incidentally, values of the Y coordinates are not changed.
X2=X5
X1=X2−width of auxiliary window (8)

In this way, the horizontal position determining processing is performed. By this processing, in the case where the display item in the main window is completely covered by the auxiliary window, such setting as to shift the position of the auxiliary window leftward is performed. As described above, in the case where a part of the display item is concealed by the auxiliary window, the position of the auxiliary window may be changed.

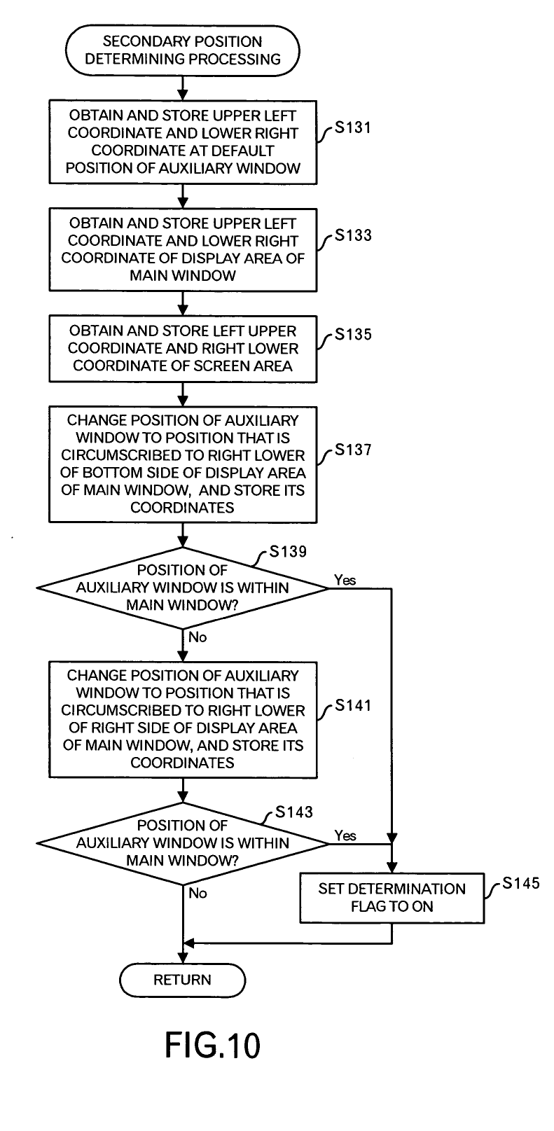

The details of the browser outside position determination processing (FIG. 7: step S73) are described with reference to FIG. 10. First, the auxiliary window display processor 135 acquires the upper left coordinate and lower right coordinate of the auxiliary window at the default position, and stores them as the temporal auxiliary window display position into the storage device such as the work memory area (FIG. 10: step S131). These coordinates are calculated at step S61 (FIG. 7). For example, the coordinates changed by the vertical position determining processing and horizontal position determining processing are returned to the default values. Next, the auxiliary window display processor 135 acquires the upper left coordinate and lower right coordinate of the display area of the main window, and stores them into the storage device such as the work memory area (step S133). In the case where the values acquired by the vertical position determining processing and horizontal position determining processing are held, they may not be acquired again here. Further, the auxiliary window display processor 135 acquires the upper left coordinate and lower right coordinate of the screen (i.e. display) area, and stores them into the storage device such as the work memory area (step S135). The coordinates of the screen (i.e. display) area are acquired from, for example, the OS.

Next, the auxiliary window display processor 135 changes the temporal auxiliary window display position to a position that is circumscribed to the lower right of the bottom side of the display area of the main window, and stores changed coordinates into the storage device such as the work memory area (step S137). For example, in the case where the lower right coordinate of the display area of the main window is (X4, Y4), it updates the upper left coordinate (X1, Y1) and lower right coordinate (X2, Y2) of the auxiliary window by using a following expression (9). Incidentally, values of the X coordinates are not changed.
Y1=Y4
Y2=Y1+height of auxiliary window (9)

The auxiliary window display processor 135 judges whether the position of the auxiliary window temporarily set at the present stage is in the screen area (step S139). For example, in the case where the upper left coordinate of the display area of the auxiliary window is (X1, Y1), the lower right coordinate thereof is (X2, Y2), the upper left coordinate of the screen area is (X7, Y7), and the lower right coordinate is (X8, Y8), when a following expression (10) is established, it is judged that the position of the auxiliary window is in the screen area.
X1>X7 and Y1>Y7 and X2<X8 and Y2<Y8 (10)

In the case where it is judged that the position of the auxiliary window is in the screen area (step S139: Yes route), the processing proceeds to step S145 described later. On the other hand, in the case where it is judged that the position of the auxiliary window is not in the screen area (step S139: No route), the auxiliary window display processor 135 changes the temporal auxiliary window display position to a position that is circumscribed to the lower right of the right side of the display area of the main window, and stores changed coordinates into the storage device such as the work memory area (step S141). For example, in the case where the upper left coordinate of the display area of the main window is (X3, Y3), and the lower right coordinate is (X4, Y4), it updates the upper left coordinate (X1, Y1) and lower right coordinate (X2, Y2) of the auxiliary window by using a following expression (11).
X1=X4
Y1=Y4−height of auxiliary window
X2=X1+width of auxiliary window
Y2=Y4 (11)

The auxiliary window display processor 135 judges whether the position of the auxiliary window temporarily set at the present stage is in the screen area (step S143). The above expression (10) is used for the judgment. In the case where the position of the auxiliary window is not in the screen area (step S143: No route), the secondary position determining processing is ended, and the processing returns to the original processing. On the other hand, in the case where it is judged that the position of the auxiliary window is in the screen area (step S143: Yes route), the auxiliary window display processor 135 sets the determination flag stored in the work memory area to “ON” (step S145). Then, the secondary position determining processing is ended, and the processing returns to the original processing.

In this way, the secondary position determining processing is performed. By this processing, in the case where the display item in the main window is completely covered by the auxiliary window, such setting as to shift the position of the auxiliary window to the outside of the main window is performed.

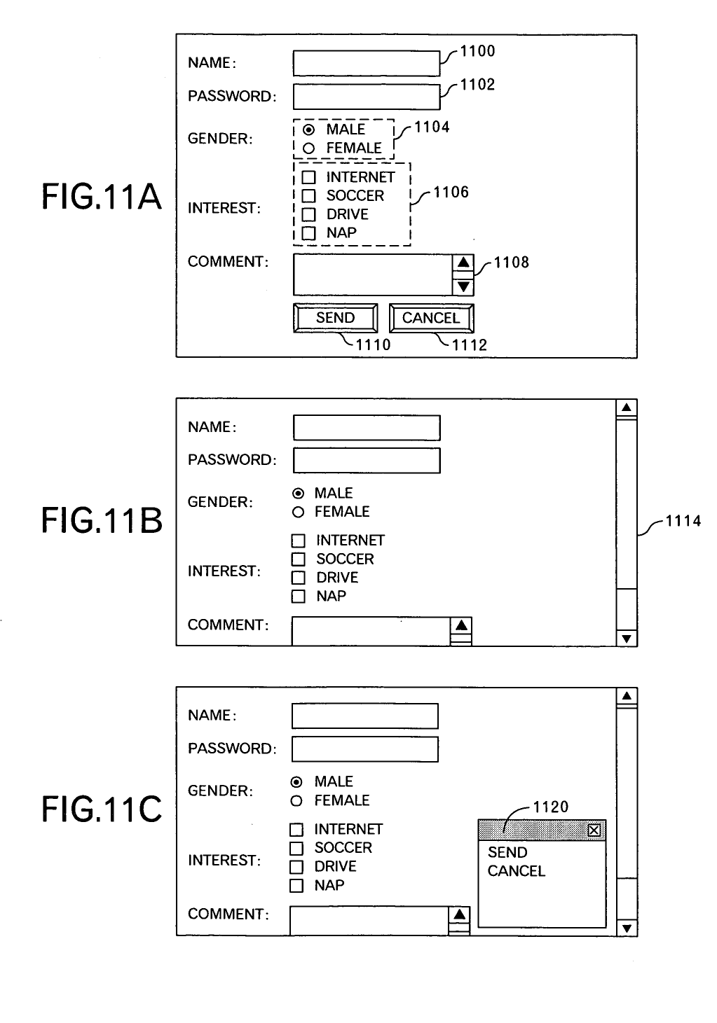

The auxiliary window is displayed in the manner as described above. FIGS. 11A to 11C show examples of the screen. The example of FIG. 11A includes a name input column 1100, password input column 1102, gender selection input column 1104, interest selection input column 1106, comment input column 1108, send button 1110, and cancel button 1112. That is, FIG. 11A shows the example in which for example, all the display items of one page are displayed in the main window.

Here, for example, in the case where the height of the main window becomes low, the screen normally becomes as shown in FIG. 11B. That is, with respect to the send button 1110 and cancel button 1112 which are displayed in the main window in the example of FIG. 11A, unless an operation of lowering a scroll bar 1114 is performed, they are not displayed in the main window in the example of FIG. 11B. However, in the screen as shown in FIG. 11B, when the operation of lowering the scroll bar 1114 is performed, the name input column 1100 and password input column 1102 are not displayed in the main window at this time. Under such circumstances, it is difficult for the user to grasp the whole of the display items contained in one page.

On the other hand, like the example shown in FIG. 11C, when an auxiliary window 1120 is displayed, even if the send button 1110 and cancel button 1112 are not displayed in the main window, the user can grasp that a link and button for “send”, and a link and button for “cancel” are contained in the original page.

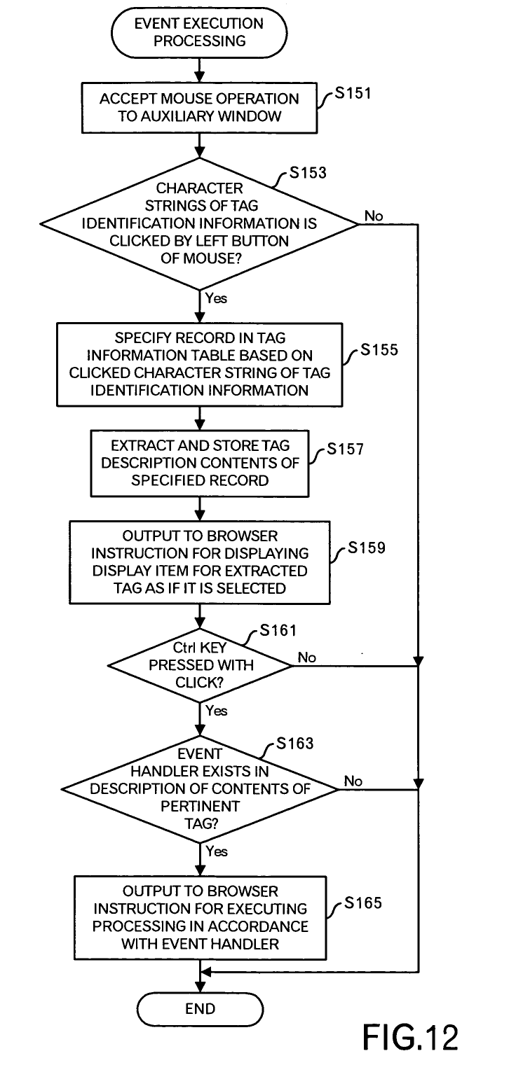

An event execution processing using the auxiliary window as stated above is described with reference to FIG. 12. First, the auxiliary window controller 131 receives a mouse operation from a user to an auxiliary window (FIG. 11: step S151). The auxiliary window controller 131 judges whether a character string of tag identification information is clicked by a left button of a mouse (step S153). Here, the character string of the tag identification information is a character string shown in the auxiliary window, and in the example of FIG. 11C, the character string “send” and character string “cancel” are items to be clicked. In the case where it is judged that the string of the tag identification information is not clicked by the left button of the mouse (step S153: No route), the processing is ended.

On the other hand, in the case where it is judged that the character string of the tag identification information is clicked by the left button of the mouse (step S153: Yes route), the auxiliary window controller 131 specifies a record of the tag information table 140 on the basis of the clicked character string of the tag identification information (step S155). Further, the auxiliary window controller 131 extracts the value of the column 302 of contents of tag description in the specified record, and temporarily stores it into the storage device such as the work memory area (step S157). The auxiliary window controller 131 outputs to the browser 110 an instruction for displaying the display item corresponding to the extracted tag as if it is selected in the main window (step S159). By this processing, a scroll is automatically performed in the main window, and the display item corresponding to the character string of the tag identification information is displayed in the main window.

In addition, the auxiliary window controller 131 judges whether the user pressed, for example, a Ctrl key together with the click (step S161). That is, it is judged whether the user clicks the character string of the tab identification information while pressing the Crtl key. In the case where the user did not press the Crtl key (step S161: No route), the processing is ended. On the other hand, in the case where the user pressed the Ctrl key together with the click (step S161: Yes route), the auxiliary window controller 131 judges whether an event handler exists in the description contents of the pertinent tag (step S163). In the case where it is judged that the event handler does not exist (step S163: No route), the processing is ended. On the other hand, in the case where it is judged that the event handler exists (step S163: Yes route), the auxiliary window controller 131 outputs an instruction for executing a processing in accordance with the event handler to the browser 110 (step S165). The browser 110 executes the processing in accordance with the event handler. Then, the processing is ended.

In this way, the event execution processing is performed. By this processing, also with respect to the display item not displayed in the main window, the user can perform the selection operation or the like using the auxiliary window.

Although one embodiment of the invention has been described, the invention is not limited to this. For example, the table structure shown in FIG. 3 is an example, and as long as similar data is stored, another structure may be adopted, or an item may be added or deleted as the need arises. Besides, the functional blocks of the user terminal shown in FIG. 1 are more examples, and may not necessarily correspond to program modules in an actual program. Besides, the functional block diagram of the computer shown in FIG. 2 is also an example, and there is also a case where it is different from an actual hardware structure. Besides, the conceptual diagram shown in FIG. 5 is an example, and there is also a case where a similar structure is expressed in a different mode. The screen examples shown in FIGS. 11A to 11C are also examples, and the screen display items are not limited to those shown in the drawings. Further, the processing flows shown in FIGS. 4, 6 to 10, and 12 are also examples, and the order of the processing may be changed within the range in which a similar processing effect is obtained, and a step may be added or deleted as the need arise.

Although the present invention has been described with respect to a specific preferred embodiment thereof, various change and modifications may be suggested to one skilled in the art, and it is intended that the present invention encompass such changes and modifications as fall within the scope of the appended claims.

1. A program embodied on a medium, comprising:
extracting a display item which is not displayed in a main window and has a predetermined attribute, and storing data concerning the extracted display item into an auxiliary window data storage; and
displaying an auxiliary window, which displays a display item corresponding to the extracted display item, at a specific position on a display screen by using said data concerning the extracted display item, which is stored in said auxiliary window data storage.

2. The program as set forth in claim 1, wherein said extracting and storing, and said displaying are carried out in a case where it is detected that contents of said main window are changed.

3. The program as set forth in claim 1, wherein said displaying comprises:
searching for a position where said auxiliary window can be displayed without completely covering any display items displayed in said main window; and
determining a display position of said auxiliary window based on a result of said searching.

4. The program as set forth in claim 3, wherein said displaying is executed when it is detected that a display position of said main window is changed on said display screen.

5. The program as set forth in claim 1, wherein said displaying comprises at least one of:
judging whether or not a position exists at which said auxiliary window can be displayed within said main window without completely covering any display items displayed in said main window; and
judging whether or not a position exists, at which said auxiliary window is circumscribed to said main window, and is included in said display screen.

6. The program as set forth in claim 1, further comprising:
if it is detected that a first display item displayed on said auxiliary window is selected, outputting instruction data to display on said main window, a second display item to be displayed within said main window, said second display item corresponding to the selected first display item.

7. The program as set forth in claim 1, wherein said predetermined attribute is an attribute indicating a display item associated with an execution of a processing.

8. The program as set forth in claim 7, further comprising:
if it is detected that a display item displayed on said auxiliary window is selected and an execution of a processing associated with the selected display item is instructed, outputting data to instruct said execution of said processing associated with the selected display item.

9. An information processing method, comprising:
extracting a display item which is not displayed in a main window and has a predetermined attribute, and storing data concerning the extracted display item into an auxiliary window data storage; and displaying an auxiliary window, which displays a display item corresponding to the extracted display item, at a specific position on a display screen by using said data concerning the extracted display item, which is stored in said auxiliary window data storage.

10. The information processing method as set forth in claim 9, wherein said extracting and storing, and said displaying are carried out in a case where it is detected that contents of said main window are changed.

11. An information processing apparatus, comprising:
an extractor that extracts a display item which is not displayed in a main window and has a predetermined attribute, and stores data concerning the extracted display item into an auxiliary window data storage; and
a display processor that displays an auxiliary window, which displays a display item corresponding to the extracted display item, at a specific position on a display screen by using said data concerning the extracted display item, which is stored in said auxiliary window data storage.

12. The information processing apparatus as set froth in claim 11, wherein said extractor operates in response to that it is detected that contents of said main window are changed.
